(19) United States
(12) Patent Application Publication
(10) Pub. No.: US 2024/0088343 A1
(43) Pub. Date: Mar. 14, 2024

(54) ELECTRODE MANUFACTURING METHOD AND ELECTRODE MANUFACTURING APPARATUS

(71) Applicants: Hiromichi KURIYAMA, Kanagawa (JP); Satoshi NAKAJIMA, Tokyo (JP); Shun GOTO, Tokyo (JP); Tomomasa KAJITA, Kanagawa (JP); Masayoshi NOMURA, Shizuoka (JP); Keigo TAKAUJI, Kanagawa (JP); Miku OHKIMOTO, Kanagawa (JP)

(72) Inventors: Hiromichi KURIYAMA, Kanagawa (JP); Satoshi NAKAJIMA, Tokyo (JP); Shun GOTO, Tokyo (JP); Tomomasa KAJITA, Kanagawa (JP); Masayoshi NOMURA, Shizuoka (JP); Keigo TAKAUJI, Kanagawa (JP); Miku OHKIMOTO, Kanagawa (JP)

(21) Appl. No.: 18/272,816

(22) PCT Filed: Feb. 28, 2022
(86) PCT No.: PCT/JP2022/008408

§ 371 Date: Jul. 18, 2023

(30) Foreign Application Priority Data
Mar. 2, 2021 (JP) 2021-032921
Dec. 28, 2021 (JP) 2021-215007

(51) Int. Cl. H01M 4/04; B23K 26/38; G06T 7/73; H01M 4/139; H01M 4/36; H01M 4/62

(52) U.S. Cl. CPC H01M 4/0402; B23K 26/38; G06T 7/73; H01M 4/139; H01M 4/366; H01M 4/62; B33Y 10/00

(57) ABSTRACT

An electrode manufacturing method includes a first step of applying an electrode liquid composition in a desired shape at a desired position on a substrate, the electrode liquid composition containing an electrode mixture material; a second step of acquiring positional information as to where the electrode liquid composition is applied; and a third step of cutting only the substrate at a desired position in a region other than an electrode mixture material region where the electrode liquid composition is applied to obtain an electrode cut out in a desired shape.

### TECHNICAL FIELD

The disclosure discussed herein relates to an electrode manufacturing method and an electrode manufacturing apparatus.

### BACKGROUND ART

Rechargeable batteries, which can be charged and discharged, have been rapidly expanding their applications in recent years, from small devices for consumer use such as wearable devices and smartphones to large devices such as electric vehicles and stationary storage batteries. In response to these diversifying needs, a new manufacturing method is desired because it is difficult to flexibly switch manufacturing types with the conventional battery electrode manufacturing method.

In the related art, the positive and negative electrodes for secondary batteries are typically manufactured by mixing a battery material containing mainly ceramics and carbon with a subordinate member such as a conductive aid and a binder to form a liquid coating, and applying the liquid coating to a metal substrate in a continuous (analog) coating manner. For example, an aluminum foil is used as a metal substrate. As a continuous (analog) coating method, for example, die coating or gravure printing is used.

The positive electrode and negative electrode coated with a positive electrode mixture layer and a negative electrode mixture layer are machined to the required size and shape, and combined with an insulating sheet composed of a separator or solid electrolyte to form a basic structure of a cell. Shape machining mainly employs a punching method with a Thomson blade. When changing the shape of the battery, it is necessary to redesign the punching die, stop the production line, and replace the punching die. In addition, as the edge shape of the positive electrode and the negative electrode becomes more complicated, the quality deterioration becomes a problem, such as chipping of the electrode mixture layers during punching.

In recent years, an electrode cutting technique using a laser has been proposed (see, for example, Patent Document 1). Laser cutting technology eliminates the need for die redesign and setup replacement, and reduces the cost associated with product type switching. Moreover, the laser cutting technology has high design flexibility and facilitates the manufacture of batteries of desired shape tailored to the shape of the device. Thus, by effectively using limited space, a high energy-density battery system can be provided.

### CITATION LIST

### Patent Literature

[PTL 1] Japanese Unexamined Patent Publication No. 2018-129222

[PTL 2] Japanese Patent No. 6432990

[PTL 3] Japanese Unexamined Patent Publication No. 2012-221912

[PTL 4] Japanese Unexamined Patent Publication No. 2018-37143

### SUMMARY OF INVENTION

### Technical Problem

However, if an attempt is made to cut the electrode including the area where the electrode mixture layers are applied with a laser, there is a concern that thermal damage to the area around the electrode cutting portion may cause a deterioration in battery performance. In addition, in order to cut the electrode mixture layers simultaneously, it is necessary to reduce the scanning speed of the laser, to increase the number of scans, or the like in comparison to cutting only a metallic foil of approximately 5 μm to 20 μm used for the substrate. As a result, the processing time using a laser is long, leading to a decrease in productivity and an increase in cost. Thus, in the related art, there appears to be no established method of manufacturing electrodes with high design flexibility, high quality, and high productivity.

The present invention has been made in view of the foregoing, and it is an object of the present invention to provide an electrode manufacturing method that achieves high design flexibility as well as high quality and high productivity.

### Solution to Problem

According to one aspect of the present disclosure, an electrode manufacturing method is provided. The electrode manufacturing method includes
a first step of applying an electrode liquid composition in a desired shape at a desired position on a substrate, the electrode liquid composition containing an electrode mixture material;
a second step of acquiring positional information as to where the electrode liquid composition is applied; and
a third step of cutting only the substrate at a desired position in a region other than an electrode mixture material region where the electrode liquid composition is applied to obtain an electrode cut out in a desired shape.

### Advantageous Effect of the Invention

The disclosed technique provides an electrode manufacturing method that achieves high design flexibility as well as high quality and high productivity.

### BRIEF DESCRIPTION OF DRAWINGS

FIG. 1 is a plan view illustrating an example of an electrode according to a first embodiment;

FIG. 2 is a cross-sectional view illustrating an example of an electrode according to the first embodiment;

FIG. 3 is a diagram (Part 1) illustrating an example of an electrode manufacturing method according to the first embodiment;

FIG. 4 is a diagram (Part 2) illustrating an example of the electrode manufacturing method according to the first embodiment;

FIG. 5 is a diagram (Part 3) illustrating an example of the electrode manufacturing method according to the first embodiment;

FIG. 6 is a diagram (Part 4) illustrating an example of the electrode manufacturing method according to the first embodiment;

FIG. 7 is a plan view illustrating an example of an electrode according to a second embodiment;

FIG. 8 is a cross-sectional view illustrating an example of the electrode according to the second embodiment;

FIG. 9 is a diagram (Part 1) illustrating an example of a method of an electrode manufacturing method according to a second embodiment;

FIG. 10 is a diagram (Part 2) illustrating an example of an electrode manufacturing method according to a second embodiment;

FIG. 11 is a plan view illustrating an example of an electrode according to a modification of the second embodiment;

FIG. 12 is a cross-sectional view illustrating an example of an electrode according to the modification of the second embodiment;

FIG. 13 is a cross-sectional view illustrating an example of an electrode according to a third embodiment;

FIG. 14A is a diagram illustrating an example of an electrode manufacturing method according to the third embodiment;

FIG. 14B is a diagram illustrating an example of an electrode manufacturing method according to the third embodiment;

FIG. 14C is a diagram illustrating an example of an electrode manufacturing method according to the third embodiment;

FIG. 15 is a cross-sectional view illustrating an example of an electrode according to a modification of the third embodiment;

FIG. 16A is a diagram illustrating an example of an electrode manufacturing method according to the modification of the third embodiment;

FIG. 16B is a diagram illustrating an example of an electrode manufacturing method according to the modification of the third embodiment;

FIG. 16C is a diagram illustrating an example of an electrode manufacturing method according to the modification of the third embodiment;

FIG. 17 is a schematic diagram (Part 1) illustrating an example of an electrode manufacturing apparatus;

FIG. 18 is a block diagram illustrating examples of main hardware components of a control device;

FIG. 19 is a block diagram illustrating examples of main functions of the control device; and

FIG. 20 is a schematic diagram (Part 2) illustrating an example of an electrode manufacturing apparatus.

### DESCRIPTION OF EMBODIMENTS

Hereinafter, embodiments for carrying out the invention with reference to the accompanying drawings will be described. In each drawing, the same components are represented by the same reference numerals and duplicated descriptions may be omitted.

### First Embodiment

### Electrode Structure

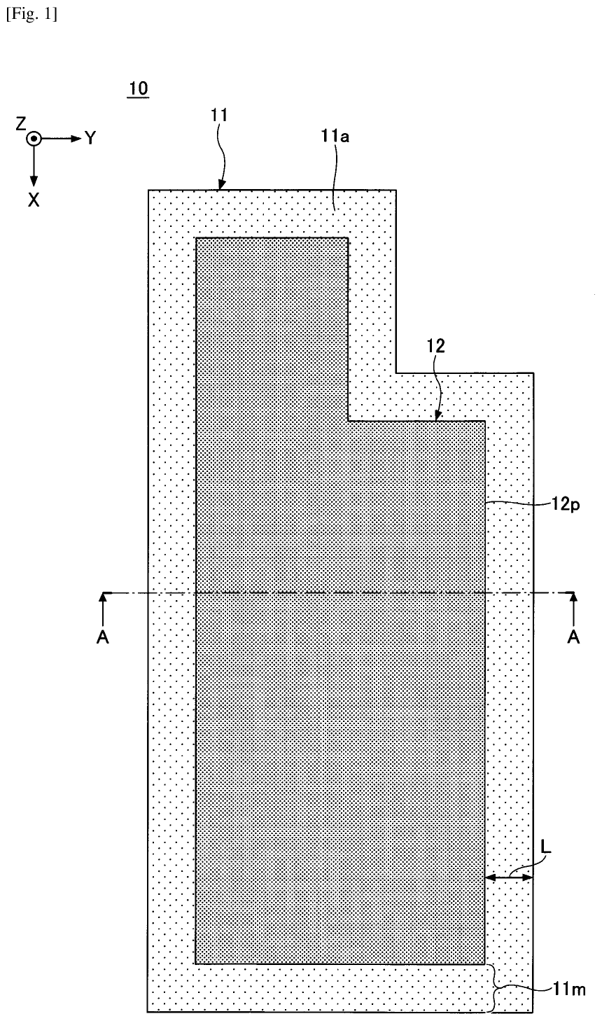

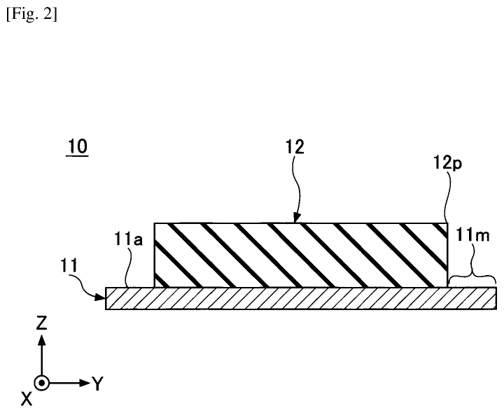

FIG. 1 is a plan view illustrating an example of an electrode according to a first embodiment. FIG. 2 is a cross-sectional view illustrating an example of an electrode according to a first embodiment, representing a cross-section along a line A-A of FIG. 1.

As illustrated in FIGS. 1 and 2, an electrode 10 includes a substrate 11 and an electrode mixture layer 12 formed on a first surface 11a of the substrate 11. The electrode 10 may be used in electrochemical devices such as, for example, primary batteries, secondary batteries, or capacitors, although it is particularly suitable for lithium ion secondary batteries. In the electrode 10, the substrate 11 may be, for example, 5 μm to 20 μm thick and the electrode mixture layer 12 may be, for example, 10 μm to 100 μm thick. The planar shape of the substrate 11 and the electrode mixture layer 12 (the shape viewed in the direction normal to the first surface 11a of the substrate 11) is an example and is not limited to the shape of FIG. 1.

In the first surface 11a of the substrate 11, an uncoated portion 11m is disposed in an annular shape on the outside of an outer peripheral portion 12p of the electrode mixture layer 12. The uncoated portion 11m is a portion from which the first surface 11a of the substrate 11 is exposed without being covered by the electrode mixture layer 12. The uncoated portion 11m is a portion represented by a low-density dot pattern illustrated in FIG. 1.

The uncoated portion is not necessarily disposed outside the outer peripheral portion 12p of the electrode mixture layer 12. For example, a through-hole may be formed through the substrate 11 and the electrode mixture layer 12. In such a case, the uncoated portion is also formed in an annular shape on the inside of an inner peripheral portion of the electrode mixture layer 12 (i.e., around the through-hole provided on the substrate 11) in a plan view.

In FIGS. 1 and 2, an X direction is a longitudinal direction of the electrode 10. A Y direction is a traverse direction of the electrode 10. A Z direction is a thickness direction of the electrode 10. The X direction, the Y direction and the Z direction are orthogonal to each other.

### Electrode Manufacturing Method

Next, a method of manufacturing an electrode according to the first embodiment will be described. The electrode mixture layer 12 can be formed on the substrate 11 by a coating process, which applies the printing process, using an electrode liquid composition. The electrode liquid composition is a material for forming the electrode mixture layer 12. The printing process preferably employs a printing process in which an electrode liquid composition can be applied in a desired shape at a desired position based on digital data, and inkjet printing is particularly preferred in view of the ability to directly print a digital image. Herein, the digital data is a series of numerical values representing information on the number or amount, for example, the coating amount, the coating shape, or the coating position of an electrode liquid composition containing an electrode mixture material.

Hereinafter, an electrode manufacturing method according to the first embodiment will be described as an example in which inkjet printing is used.

(Step of Applying an Electrode Liquid Composition Containing an Electrode Mixture Material onto a Substrate)

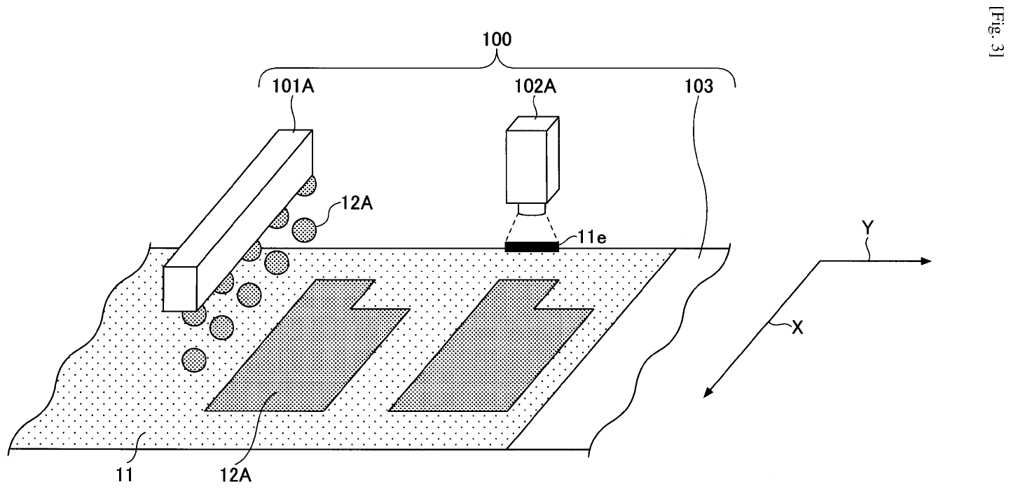

FIG. 3 is a diagram illustrating an example of the electrode manufacturing method according to the first embodiment (Part 1), schematically illustrating a step of applying an electrode liquid composition containing an electrode mixture material onto a substrate.

In FIG. 3, an electrode manufacturing apparatus 100 includes an inkjet head 101A, an image sensor 102A, and a conveying belt 103. The electrode manufacturing apparatus 100 may include a plurality of inkjet heads and a plurality of image sensors.

The inkjet head 101A is a line head and discharges an electrode liquid composition containing the electrode mixture material 12A, such as ink, on the substrate 11. The inkjet head 101A includes a plurality of nozzles disposed in a direction perpendicular to a conveying direction. The inkjet head 101A can apply the electrode liquid composition containing the electrode mixture material 12A to a desired position in a desired shape on the substrate 11.

The image sensor 102A acquires positional information to apply, for example, an electrode liquid composition containing the electrode mixture material 12A. The mage sensor 102A may be, for example, a CCD (Charge Coupled Device), CMD (Cold Metal Detector), or a CMOS (Complementary Metal Oxide Semiconductor). The image sensor 102A may be selected from those described above depending on the required reading accuracy and speed.

The conveying belt 103 is, for example, an endless belt that is looped over between two rollers to rotate. Herein, the conveying direction (sub-scanning direction) of the conveying belt 103 is in a Y direction, and the direction perpendicular to the conveying direction (main scanning direction) is in an X direction. These directions correspond with the X and Y directions in FIGS. 1 and 2.

The electrode manufacturing apparatus 100 determines, on the basis of the information acquired by the image sensor 102A, a position on the substrate 11 at which the electrode liquid composition containing the electrode mixture material 12A is to be applied, before applying the electrode liquid composition containing the electrode mixture material 12A onto the substrate 11. For example, the image sensor 102A reads a distance from an end 11e of the substrate 11 along the width direction (the X direction) of the substrate 11 and calculates the coating interval of the electrode liquid composition containing the electrode mixture material 12A according to the speed at which the substrate 11 is conveyed along the conveying direction Y.

As illustrated in FIG. 3, for example, the elongated substrate 11 is disposed on the conveying belt 103. While the conveying belt 103 conveys the substrate 11 along the conveying direction Y, the inkjet head 101A discharges the electrode liquid composition containing the electrode mixture material 12A from the nozzle. This causes the electrode liquid composition containing the electrode mixture material 12A to be applied onto the substrate 11 in a predetermined shape. The electrode liquid composition containing the electrode mixture material 12A is applied to the substrate 11 and dried in a drying process to form the electrode mixture layer 12.

By using a method by which the digital image can be printed directly, such as inkjet printing, the electrode liquid composition containing the electrode mixture material 12A can be applied to the substrate 11 in a desired shape based on the digital source. Digital data can be generated using, for example, commercially available drawing software such as Adobe Illustrator.

(Step of Acquiring Positional Information on which an Electrode Liquid Composition Containing an Electrode Mixture Material is Applied)

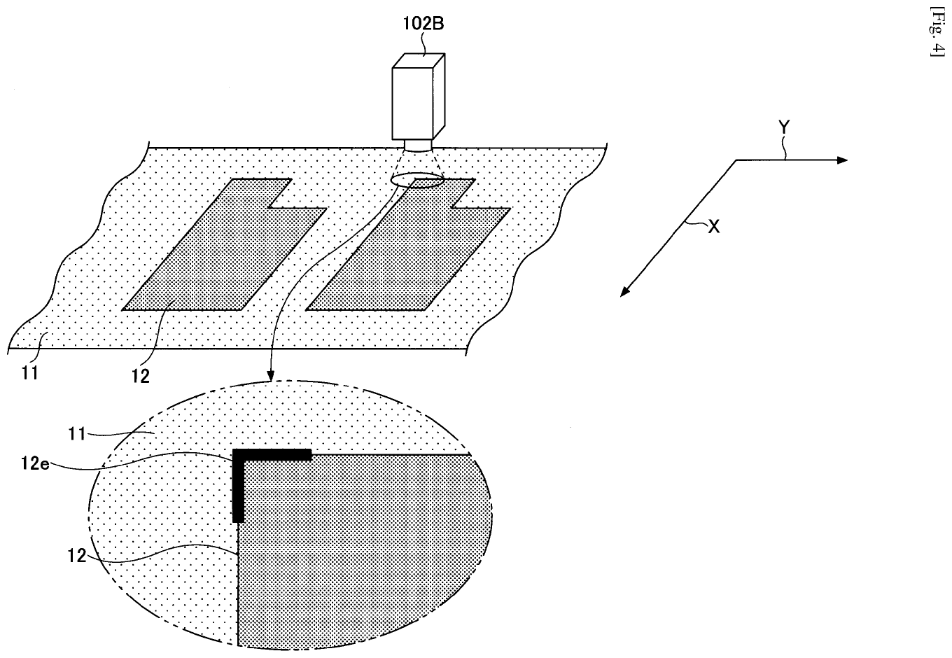

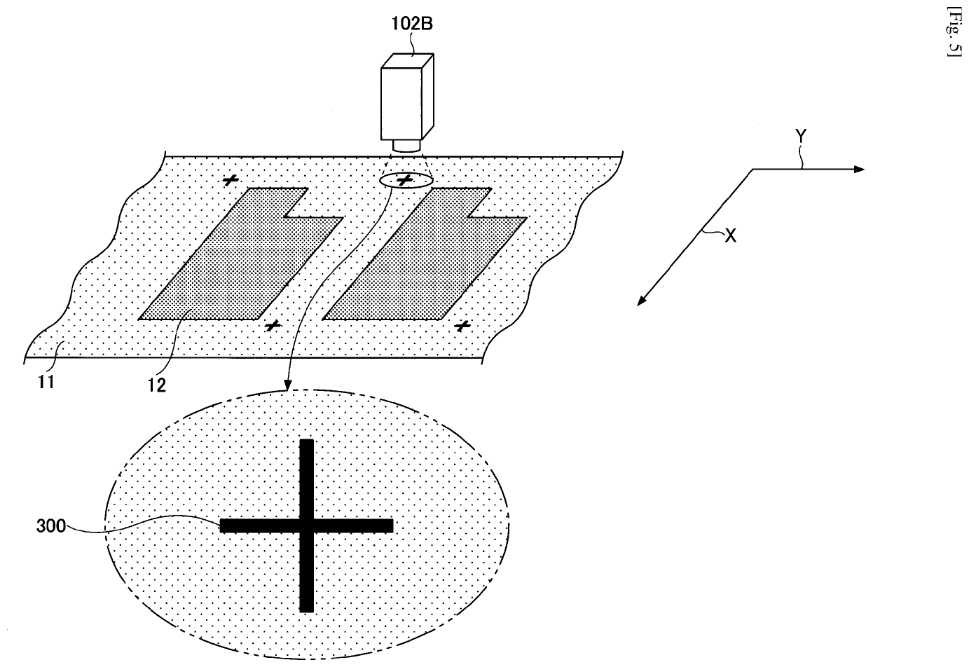

FIGS. 4 and 5 are diagrams (Part 2) and (Part 3) illustrating examples of the electrode manufacturing method according to the first embodiment, which schematically illustrate steps of acquiring positional information of the electrode mixture layer 12 (i.e., positional information of an electrode liquid composition containing the applied electrode mixture material 12A).

The positional information of the electrode mixture layer 12 can be acquired, for example, by image recognition. Alternatively, the positional information of the electrode mixture layer 12 may be acquired by irradiating the substrate 11 and the electrode mixture layer 12 with light and receiving reflected light to detect a step difference between the substrate 11 and the electrode mixture layer 12. The method of using image recognition is preferable because image recognition is not susceptible to disturbance such as vibration of the conveying belt 103, and the positional information of the electrode mixture layer 12 can be accurately acquired. Hereinafter, an example will be described in which positional information of the electrode mixture layer 12 is acquired by image recognition.

As illustrated in FIG. 4, positional information of the electrode mixture layer 12 can be acquired using the image sensor 102B. Specifically, the image sensor 102B can acquire positional information of the electrode mixture layer 12 by, for example, image recognition performed with respect to an end shape 12e of an electrode mixture material region where the electrode liquid composition containing the electrode mixture material 12A is applied (a region in which the electrode mixture layer 12 is formed).

As illustrated in FIG. 5, the image sensor 102B may acquire positional information of the electrode mixture layer 12 by image recognition performed with respect to a mark (alignment mark) formed in a region other than the electrode mixture material region where the electrode liquid composition containing the electrode mixture material 12A is applied (the region in which the electrode mixture layer 12 is formed). Specifically, positional information of the electrode mixture layer 12 can be imaged using at least two alignment marks 300 applied in the vicinity of the electrode mixture layer 12. The image sensors may be positioned with respect to alignment marks on a one-to-one basis.

Among these methods, the method of image recognition using an alignment mark 300 is preferred in that the method is not necessary to change the image recognition algorithm depending on the shape of the electrode mixture layer 12. Alignment marks 300 may be formed, for example, by inkjet printing or laser imprinting.

When inkjet printing is used, the alignment mark 300 may be formed by printing a coloring material recognizable by the image sensor 102B on the substrate 11 in a cross shape, for example. The coloring material used for forming the alignment mark 300 may be the same material as the material used for forming the electrode mixture layer 12, or when the coloring material is inkjet ejectable, a material different from the material used for forming the electrode mixture layer 12 may be used.

In this case, it is preferable to use the same material as the material used for forming the electrode mixture layer 12 as the coloring material of the alignment mark 300. As a result, the inkjet head and ink for printing the material used for forming the alignment mark 300 can be shared with the inkjet head and ink for printing the material used for forming the electrode mixture layer 12, thereby simplifying the construction of the printing system.

Note that in addition to the above-described printing, the alignment mark 300 may be formed by using a laser. For example, a laser may be used to create, for example, a cross-shaped through-hole in substrate 11, and this cross-shaped through-hole may be used as an alignment mark 300.

(Step of Cutting an Electrode)

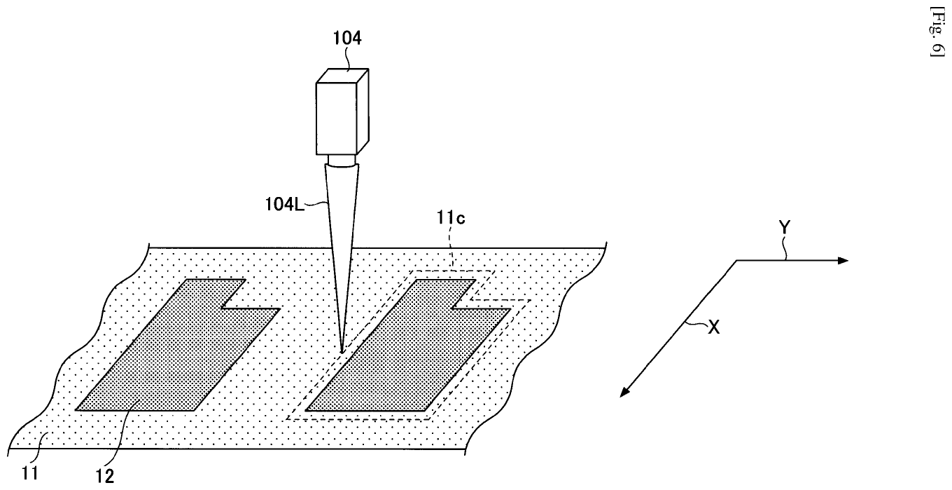

FIG. 6 is a diagram (Part 4) illustrating an example of an electrode manufacturing method according to a first embodiment, schematically illustrating a step of cutting an electrode in a desired shape.

After image recognition is performed to recognize the positional information of the electrode mixture layer 12 (i.e., the positional information of the electrode liquid composition comprising the applied electrode mixture material 12A), only the substrate 11 is cut at a desired position in the region other than the electrode mixture material region where the electrode liquid composition containing the electrode mixture material 12A is applied. For example, as illustrated in FIG. 6, only the substrate 11 is cut at a desired position 11c (i.e., not the region where the electrode liquid composition containing the electrode mixture material 12A is applied) outside the electrode mixture layer 12 of the substrate 11. This enables an electrode 10 (see FIGS. 1 and 2) having a desired shape to be made by cutting out the electrode liquid composition containing the electrode mixture material 12A.

As a method of cutting only the substrate 11, a method by which a processing position can be optionally specified by digital data is preferable, and a method of using laser light 104L applied from a laser head 104 is more preferable. An attenuator for laser power adjustment, a reflective mirror, a beam expander for laser beam diameter adjustment, a Galvano scanner for laser scanning, a condenser lens, and the like may be optionally provided between the laser head 104 and the substrate 11. As a wavelength range of the laser light 104L, a visible to ultraviolet wavelength range is preferably used from the viewpoint of processing accuracy, and an oscillation pulse width is preferably shorter than nanoseconds, and is more preferably tens of picoseconds, in view of the thermal effect of the substrate 11.

(Effect of Combining Digital Printing and Digital Processing Technologies)

As described above, by combining inkjet printing, which is a digital printing technology, and laser cutting, which is a digital processing technology, by changing the digital data that is commonly available in each technology, the electrode mixture layer 12 can be efficiently manufactured in a desired shape. That is, the electrode manufacturing apparatus 100 can control, based on digital data, a desired position as to where the electrode liquid composition containing the electrode mixture material is applied, a desired shape of the electrode liquid composition containing the electrode mixture material, and a desired position as to where the substrate is cut. This enables a method of manufacturing electrodes with a high design flexibility.

The cutting of an electrode by laser cutting is disclosed, for example, in Patent Document 1 (Japanese Unexamined Patent Publication No. 2018-129222), Patent Document 2 (Japanese Patent No. 6432990), Patent Document 3 (Japanese Unexamined Patent Publication No. 2012-221912), and Patent Document 4 (Japanese Unexamined Patent Publication No. 2018-37143). However, any of these disclosed technologies relates to a method of cutting a substrate together with an electrode liquid composition containing an electrode mixture material applied to the substrate by a laser for an electrode intermittently coated or continuously coated with a material forming the electrode.

In these methods, the laser cutting efficiencies of the substrate and the electrode liquid composition containing the electrode mixture material are largely different. Thus, as disclosed in Patent Document 3, the laser intensity needs to be changed according to the change in the cutting site, or as disclosed in Patent Document 4, the laser energy cannot be absorbed depending on the material of the electrode liquid composition containing the electrode mixture material. As a result, steps of manufacturing an electrode becomes complicated, such as the need for a step of printing the laser light absorbing member.

Also, the cutting speed of the electrode liquid composition containing the electrode mixture material is much lower than the cutting speed of the substrate, resulting in a decrease in the production efficiency of the electrode cutting process. In addition, Patent Document 1 (Japanese Unexamined Patent Publication No. 2018-129222) discloses that the thermal effect of laser upon cutting the electrode liquid composition containing the electrode mixture material cannot be ignored.

In the electrode manufacturing method according to the first embodiment, when the electrode liquid composition containing the electrode mixture material 12A is digitally printed in a desired shape in response to such a problem, only the substrate 11 can be laser cut in order to avoid the position where the electrode liquid composition containing the electrode mixture material 12A is applied. By cutting only the substrate 11 without cutting the electrode mixture layer 12, it is possible to prevent the complicated step such as detailed design of the laser strength in the cutting step of the electrode, and reduced productivity, and it is possible to obtain an electrode having a stable quality and a desired shape without having the electrode liquid composition containing the electrode mixture material being affected by heat near the cutting end. That is, in the electrode manufacturing method according to the first embodiment, a high quality and high productivity electrode manufacturing method can be obtained.

The electrode manufacturing method according to the first embodiment is to cut nothing other than the substrate 11 by a laser while avoiding the electrode mixture layer 12. Accordingly, as illustrated in FIGS. 1 and 2, an uncoated portion 11m is disposed on the first surface 11a of the substrate 11, which is disposed around the electrode mixture material region in which the electrode mixture layer 12 is formed. The length L of the uncoated portion 11m (see FIG. 1) can be appropriately adjusted according to the oscillation pulse width in laser cutting. The length L of the uncoated portion 11m is preferably 10 μm or more and 500 μm or less. If the length L is less than 10 μm, the electrode liquid composition containing the electrode mixture material, which forms the electrode mixture layer 12, gets thermally affected and degrades. If the length L is greater than 500 μm, the ratio of the area occupied by the electrode mixture layer 12 to the area of the substrate 11 decreases, thereby reducing the energy density of the battery.

The electrode 10 will be described in detail below.

(Substrate 11)

The substrate 11 may employ a variety of metallic foils or insulating substrates. There are no particular restrictions to the form of the substrate 11, and the form of the substrate 11 may be, for example, for example, a single sheet or a long strip. Examples of metallic foils include copper foils, aluminum foils, stainless steel foils, and nickel foils. Examples of insulating substrates include glass, glass epoxy, polyimide (PI), polyethylene naphthalate (PEN), polyethylene terephthalate (PET), cellulose paper, and rubber.

(Electrode Liquid Composition Containing Electrode Mixture Material 12A)

The electrode liquid composition applied by inkjet printing includes at least one of a positive electrode active material and a negative electrode active material. The electrode liquid composition applied by inkjet printing may further optionally include one or more of a dispersion medium, a dispersant, a conductive aid, a binder, a non-aqueous electrolyte, a solid electrolyte, a gel electrolyte, or a monomer that becomes a gel electrolyte through a polymerization process.

(Positive Electrode Active Material)

The positive electrode active material may be used alone or mixed with two or more types. Examples of the positive electrode active material include, but not particularly limited to, alkali metal-containing transition metal compounds, provided that an alkali metal ion can be reversibly absorbed and released.

Examples of alkali metal-containing transition metal compounds include lithium-containing transition metal compounds such as complex oxides containing lithium and one or more elements selected from the group consisting of cobalt, manganese, nickel, chromium, iron, and vanadium.

Examples of lithium-containing transition metal compounds include lithium-containing transition metal oxides such as lithium cobaltate, lithium nickelate, or lithium manganate.

As the alkali metal-containing transition metal compound, a polyanionic-based compound having an XO₄ tetrahedra (X=P, S, As, Mo, W, or Si, etc.) in the crystalline structure may also be used. Among these, lithium-containing transition metal phosphates, such as lithium iron phosphate or lithium vanadium phosphate, are preferred in terms of cycle characteristics. Particularly, lithium vanadium phosphate has a high diffusion coefficient of lithium and excellent output characteristics.

It is preferable that the surface of the polyanionic-based compound be coated with a conductive aid such as a carbon material and combined in terms of electron conductivity.

Examples of sodium-containing transition metal compounds include oxides of the NaMO₂ type, sodium chromate (NaCrO₂), sodium ferrate (NaFeO₂), sodium nickelate (NaNiO₂), sodium cobaltate (NaCoO₂), sodium manganate (NaMnO₂), or sodium vanadate (NaVO₂). A portion of M may be substituted with at least one of the metallic elements other than M and Na, such as Cr, Ni, Fe, Co, Mn, V, Ti, and Al. Also, as the sodium-containing metal oxide, Na₂FePO₄F, NaVPO₄F, NaCoPO₄, NaNiPO₄, NaMnPO₄, NaMn_{1.5}Ni_{0.5}O₄, or Na₂V₂(PO₄)₃ may be used.

(Negative Electrode Active Material)

The negative electrode active material may be a material capable of absorbing and desorbing metals alloyed with alkali metal ions, such as Li ions or Na ions. Examples of such materials include inorganic compounds such as composite oxides of transition metal and Li, metal oxides, alloy-based materials, or transition metal sulfides, carbon materials, organic compounds, Li metals, and Na metals.

Composite oxides include LiMnO₂, LiMn₂O₄, lithium titanate (Li₄Ti₅O₁₂, Li₂Ti₃O₇), lithium manganate (LiMg_{1/2}Ti_{3/2}O₄), lithium cobalt titanate (LiCo_{1/2}Ti_{3/2}O₄), lithium zinc titanate (LiZn_{1/2}Ti_{3/2}O₄), lithium iron titanate (LiFeTiO₄), lithium chromium titanate (LiCrTiO₄), lithium strontium titanate (Li₂SrTi₆O₁₄), or lithium barium titanate (Li₂BaTi₆O₁₄).

Examples of sodium composite oxides include sodium titanate, such as Na₂Ti₃O₇ or Na₄Ti₅O₁₂. A portion of the Ti or Na of the sodium titanate may be replaced by other elements. Such elements include, for example, at least one selected from the group consisting of Ni, Co, Mn, Fe, Al, and Cr.

Examples of metal oxides include TiO₂, Nb₂TiO₇, WO₃, MoO₂, MnO₂, V₂O₅, SiO₂, SiO, or SnO₂.

Examples of alloy-based materials include Al, Si, Sn, Ge, Pb, As, or Sb. Examples of transition metal sulfides include FeS or TiS. Carbon materials include graphite, non-graphitizing carbons and graphitizing carbons. As the inorganic compound, a compound in which the transition metal of the complex oxide described above is substituted with a heterogeneous element may be used.

These negative electrode active materials may be used alone, or in combination with two or more types.

(Dispersion Medium)

Insofar as the dispersion medium is capable of dispersing the active material, examples of the dispersion medium include, but are not particularly limited to, water, ethylene glycol, or an aqueous dispersion medium such as propylene glycol; N-methyl-2-pyrrolidone, 2-pyrrolidone, cyclohexanone, ethyl lactate, butyl acetate, mesitylene, ethylene glycol monoethyl ether, ethylene glycol monobutyl ether, ethylene glycol monoethyl ether, diethylene glycol monobutyl ether, propylene glycol monomethyl ether, propylene glycol monoethyl ether, propylene glycol monobutyl ether, dibutyl ether, diethyl ether, di-tert-butyl ether, 2-n-butoxymethanol, 2-dimethyl ethanol, N,N-dimethyl acetamide anisole, diethoxyethane, n-hexane, heptane, octane, nonane, decane, or, an organic dispersion medium such as p-menthane. The dispersion medium may be used alone or in combination with two or more types.

(Conductive Aids)

Conductive aids may be combined with an active material in advance or added when preparing the dispersion.

Examples of the conductive aid may include a conductive carbon black formed by a furnace process, an acetylene process, or a gasification process, and carbon materials such as carbon nanofibers, carbon nanotubes, graphene, or graphite particles.

For example, a metal particle such as aluminum or a metal fiber may be used as a conductive aid other than a carbon material.

The mass ratio of the conductive aid to the active material is preferably 10% or less, and more preferably 8% or less. When the mass ratio of the conductive aid to the active material is 10% or less, the stability of the dispersion is improved.

(Dispersant)

Insofar as those can improve the dispersibility of the active material, the polymeric particles, or the conductive aids in the dispersion medium, examples of the dispersant include, but are not particularly limited to, polymer types such as polycarboxylic acid-based, naphthalene sulfonic acid formarin condensation-based, polyethylene glycol, polycarboxylic acid partially alkyl ester-based, polyether-based, polyalkylene polyamine-based, and the like; surfactant types such as alkyl sulfonic acid-based, quaternary ammonium-based, higher alcohol alkylene oxide-based, polyhydric alcohol ester-based, alkyl polyamine-based, and the like; or inorganic types such as polyphosphate-based.

(Binder)

The binder can ensure adhesion by adding a dispersant or electrolyte material to the positive electrode material or to the negative electrode material when the bonding between the positive electrode material or the negative electrode material and the electrically conductive layer is insufficient. The binder is not particularly limited to, insofar as those can apply a cohesive force, a compound that does not increase its viscosity is preferred, from the viewpoint of discharge performance of inkjet. The binder can be obtained by a process of polymerizing a monomeric compound after inkjet printing of the monomeric compound, or the binder can be obtained by a process of using polymeric particles. In addition, as a material that does not increase the viscosity of the liquid composition, a polymeric compound or the like that can be dispersed in the dispersion medium may be used. In addition, in the case where a polymeric compound capable of being dissolved in the dispersion medium is used, such it may be sufficient that the liquid composition in which the polymeric compound is dissolved in the dispersion medium has a viscosity capable of being discharged from the liquid discharge head.

Examples of using a monomeric compound include applying a dispersion in which a compound having a polymerizable site and a compound containing a polymerization initiator or catalyst are dissolved, followed by heating or applying non-ionizing radiation, ionizing radiation or infrared radiation.

In a compound having a polymerizable site, the polymerizable site may be one in the molecule or polyfunctional. The polyfunctional polymerizable compound means a compound having two or more polymerizable groups. Polyfunctional polymerizable compounds are not particularly limited insofar as those can be heated or polymerized by non-ionizing radiation, ionizing radiation, or infrared radiation. Examples of polyfunctional polymerizable compounds include acrylate resins, methacrylate resins, urethane acrylate resins, vinyl ester resins, unsaturated polyesters, epoxy resins, oxetane resins, vinyl ethers, or resins utilizing an en-thiol reaction. Among these, the acrylate resins, the methacrylate resins, the urethane acrylate resins, or the vinyl ester resins are preferable from the viewpoint of productivity.

Examples of a material constituting the polymeric particles include polyvinylidene fluoride, acrylic resin, polyamide compounds, polyimide compounds, polyamidoimide, ethylene-propylene-butadiene rubber (EPBR), styrene-butadiene copolymer, nitrile butadiene rubber (HNBR), isoprene rubber, polyisobutene, polyethylene glycol (PEO), polymethylmethacrylic acid (PMMA), polyethylene vinyl acetate (PEVA), polyethylene, polypropylene, polyurethane, nylon, polytetrafluoroethylene, polyphenylene sulfide, polyethylene tephthalate, or polybutylene tephthalate.

Examples of polymeric compounds include polyamide compounds, polyimide compounds, polyamidoimides, ethylene-propylene-butadiene rubber (EPBR), styrene-butadiene rubber (SBR), nitrile butadiene rubber (NBR), isoprene rubber, polyisobutene, polyethylene glycol (PEO), polymethylmethacrylic acid (PMMA), or polyethylene vinyl acetate (PEVA).

The mass ratio of the binder to the active material is preferably 10% or less and more preferably 5% or less. When the mass ratio of the binder to the active material is 10% or less, the bonding force during the electrode formation is improved without impairing the discharge performance.

### Second Embodiment

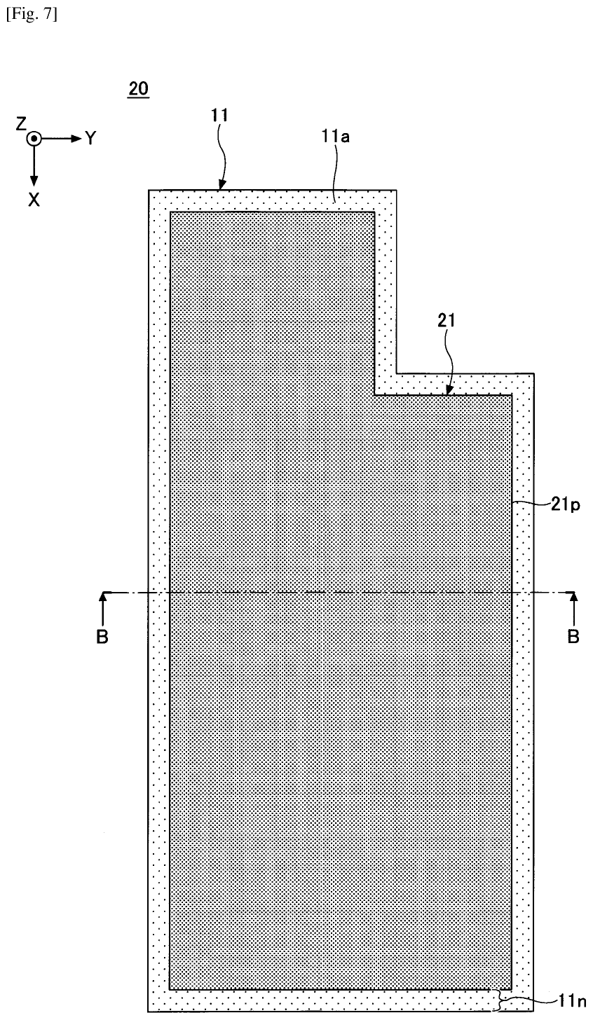

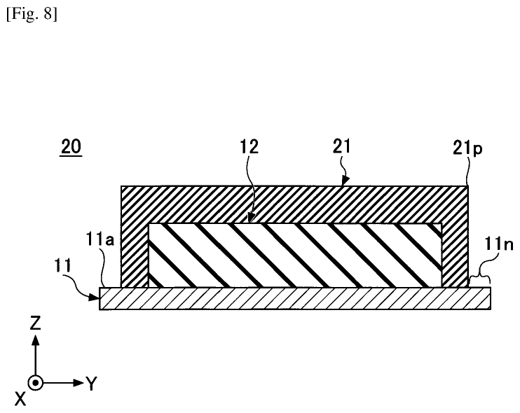

In a second embodiment, an example of an electrode having an electron insulating layer is illustrated. FIG. 7 is a plan view illustrating an example of an electrode according to a second embodiment. FIG. 8 is a cross-sectional view illustrating an example of the electrode according to a second embodiment, representing a cross-section along a line B-B of FIG. 7.

As illustrated in FIGS. 7 and 8, an electrode 20 differs from the electrode 10 (see FIGS. 1 and 2) in that an electron insulating layer 21 is formed. The electron insulating layer 21 preferably covers all of the top and side surfaces of the electrode mixture layer 12 and the electrode mixture layer 12 preferably has no portion exposed from the electron insulating layer 21.

In the first surface 11a of the substrate 11, an uncoated portion 11n is disposed in an annular shape on the outside of an outer peripheral portion 21p of the electron insulating layer 21 in a plan view. The uncoated portion 11n is an exposed portion of the first surface 11a of the substrate 11 without being covered by the electrode mixture layer 12 or the electron insulating layer 21. The uncoated portion 11n is represented by a portion with a low-density dot pattern illustrated in FIG. 7.

(Multilayer Application of Solid Electrolytes or Gel Electrolytes, Etc.)

FIG. 9 is a diagram illustrating an example of an electrode manufacturing method according to the second embodiment. As illustrated in FIG. 4 or 5, after positional information of the electrode mixture layer 12 is acquired by image recognition, an electrolyte liquid composition 21A containing a solid electrolyte or gel electrolyte for formation of the electron insulating layer 21 on the electrode mixture layer 12, as illustrated in FIG. 9, is inkjet printed. The electrolyte liquid composition 21A is then applied to cover the entire surface (top surface and side surfaces) of the electrode mixture layer 12. The electrolyte liquid composition 21A upon drying becomes an electron insulating layer 21. Note that the electrolyte liquid composition 21A is an example of a liquid composition containing an electron insulating layer forming material without containing an active material. The electron insulating layer forming material is herein a solid electrolyte or a gel electrolyte.

As in the first embodiment, the substrate 11 is cut at a desired position in a region where the electron insulating layer 21 is not formed (a region where the electrolyte liquid composition 21A is not applied). Thus, as illustrated in FIGS. 7 and 8, in the electrode 20, the electrode mixture layer 12 can be prevented from being exposed, and an electrode end structure capable of preventing short circuiting inside the battery due to slippage of active material or the like can be obtained.

(Electrolyte Liquid Composition)

As the electrolyte liquid composition 21A a liquid composition obtained by dispersing a solid electrolyte in a dispersion medium can be used, for example. The electrolyte liquid composition 21A may further optionally include a dispersant, a binder, or a monomer that polymerizes via a polymerization process. The mean particle size of the solid electrolyte is preferably 10 μm or less, and more preferably 5 μm or less. When the mean particle size of the solid electrolyte is 10 μm or less, discharge stability and settling resistance of the liquid composition are improved. A d10 of the solid electrolyte is preferably 0.1 μm or more. The d10 of the solid electrolyte greater than 0.1 μm improves the storage stability of the liquid composition.

The electrolyte liquid composition according to the second embodiment may not include a solid electrolyte and may include a gel electrolyte. The gel electrolyte includes a resin and a non-aqueous electrolyte, ionic liquid, glyme, or electrolyte salt as described above. Preferably, the viscosity of the liquid composition at 25° C. is in the range from 3 mPa·s to 100 mPa·s or less. More preferably, the viscosity of the liquid composition at 25° C. is 9 mPa·s or more and 50 mPa·s or less.

(Solid Electrolyte or Gel Electrolyte)

Ceramic Solid Electrolyte for Lithium-Ion Secondary Batteries

As the electrolyte, a solid electrolyte of ceramics such as oxide or sulfide, a gel electrolyte, or a ceramic-polymer composite electrolyte can be used.

Examples of oxides include LISICON-type oxides including γ-Li₃PO₄, Li₃BO₄, 0.75Li₄GeO₄-0.25Li₂ZnGeO₄ solid solution, Li₄SiO₄—Zn₂SiO₄ solid solution, Li₄GeO₄—Li₃VO₄ solid solution, NASICON-type oxides including Li_{1.3}Al_{0.3}Ti_{1.7}(PO₄)₃ or Li_{1.6}Al_{0.6} Ge_{0.8}Ti_{0.6}(PO₄)₃, perovskite-type structure (Li, La) TiO₃, garnet-type oxide La₅Li₃Nb₂O₁₂, Li₅La₃TaO₁₂, or Li₇La₃Zr₂O₁₂.

Examples of sulfides include Li₄GeS₄—Li₃PS₄ solid solution, Li₄SiS₄—Li₃PS₄ solid solution, Li₃PS₄—Li₂S solid solution, Li₂S—P₂S₅ solid solution, Li₂S—SiS₂, Li₁₀GeP₂S₁₂, Argyrodite type Li₆PS₅X (X=Cl, Br, I), or L₇P₃S₁₁ crystals.

(Ceramic Solid Electrolyte for Sodium-Ion Secondary Batteries)

Examples of oxides include NASICON-type Na₁₊ₓZr₂SiₓP₃₋ₓO₁₂ (0≤x≤1) or β-alumina-type Na₂O-11Al₂O₃. Examples of sulfides include Na₂S—P₂S₅, Na₃PS₄, Na₃SbS₄, Na₂S—SiS₂, or Na₂S—GeS₂. Examples of selenide include Na₃PSe₄.

(Gel Electrolyte)

Gel electrolytes include resins and non-aqueous electrolytes, ionic liquids, glyme, or electrolyte salts. Examples of resins for gel electrolytes include polymers or polymerizable monomers used in the binders.

The electrode liquid composition for printing the alignment mark 300 may be an electrode liquid composition containing a conductive material such as a positive electrode active material, a negative electrode active material, or a conductive aid, or an electrode liquid composition containing an insulating material such as a solid electrolyte or a semi-solid electrolyte. In view of the adhesion to the electrode mixture layer due to dropping off during cutting, it is more preferable to print an electrode liquid composition made of an insulating material such as a solid electrolyte or a semi-solid electrolyte in terms of safety.

(Non-Aqueous Electrolyte)

At least one of the resins for a gel electrolyte is mixed with a non-aqueous electrolyte containing an electrolyte salt such that the weight ratio of the non-aqueous electrolyte to the resin is between 50% or more and 2,000% or less. The concentration of the electrolyte salt in the non-aqueous electrolyte can be appropriately selected depending on the purpose, but in the case of a swing type power storage element, the concentration of the electrolyte salt in the non-aqueous electrolyte may preferably be between 1 mol/L and 2 mol/L, and in the case of a reservoir type power storage element, the concentration of the electrolyte salt in the non-aqueous electrolyte may preferably be between 2 mol/L and 4 mol/L. There is no particular limitation to materials to be used for the non-aqueous electrolyte, and the non-protic organic solvent may preferably be selected depending on the purpose.

As the aprotic organic solvent, a carbonate-based organic solvent, such as a chain-type carbonate or a cyclic carbonate, may be used. Of these, the chain-type carbonate is preferable because of the high solubility of the electrolyte salt. Also, the aprotic organic solvent is preferable because of a low viscosity in terms of discharge stability.

Examples of chain-type carbonates include dimethyl carbonate (DMC), diethyl carbonate (DEC), or methyl ethyl carbonate (EMC).

The content of the chain-type carbonate in the non-aqueous solvent is not particularly limited and may be appropriately selected depending on the purpose, but the content of the chain-type carbonate in the non-aqueous solvent is preferably 50 wt % or more. When the content of the chain-type carbonate in the non-aqueous solvent is 50 wt % or more, the cyclic material content is reduced even when the solvent other than the chain-type carbonate is a cyclic material with a high dielectric constant (e.g., cyclic carbonate or ester). Accordingly, even when a non-aqueous electrolyte having a high concentration of 2 M or more is manufactured, the viscosity of the non-aqueous electrolyte is reduced, and impregnation and ion diffusion into the electrode of the non-aqueous electrolyte is improved.

Examples of cyclic carbonates include propylene carbonate (PC), ethylene carbonate (EC), butylene carbonate (BC), or vinylene carbonate (VC).

The non-aqueous solvent other than the carbonate-based organic solvent may be an ester-based organic solvent, such as a cyclic ester or a chain-type ester, an ether-based organic solvent, such as a cyclic ether or a chain-type ether, as necessary.

Examples of cyclic esters include γ-butyrolactone (γBL), 2-methyl-γ-butyrolactone, acetyl-γ-butyrolactone, or γ-valerolactone.

Examples of chain-type esters include alkyl esters of propionate, dialkyl esters of malonate, alkyl esters of acetate (methyl (MA) acetate, ethyl acetate, etc.) or alkyl esters of formate (methyl (MF) formate, ethyl formate, etc.), and the like.

Examples of cyclic ethers include tetrahydrofuran, alkyltetrahydrofuran, alkoxyte-trahydrofuran, dialkoxytetrahydrofuran, 1,3-dioxolane, alkyl-1,3-dioxolane, or 1,4-dioxolane.

Examples of chain-type ethers include 1,2-dimethociquiethane (DME), diethyl ether, ethylene glycol dialkyl ether, diethylene glycol dialkyl ether, triethylene glycol dialkyl ether, or tetraethylene glycol dialkyl ether.

(Ionic Liquid)

As ionic liquids, cationic species include Li⁺ or Na⁺, which include at least one of BMP (1-butyl-1-methylpyrrolidinium), EMI (1-ethyl-3-methylimidazolium), and BMMI (1-butyl-2,3-dimethylimidazolium), and anionic species include TFSI (bis(trifluoromethaneSulfonyl)imide or FSI (bisfluorosulfonyl)imide.

(Glyme)

As the glyme, triflame (G3) or tetraglyme (G4) represented by R—O—(CHCHO)ₙR, wherein n=3 or 4, which generally forms a stable Lewis acid-base 1:1 complex cation may be used.

(Electrolyte Salt)

The electrolyte salts not particularly limited insofar as those have high ionic conductivity and can be dissolved in a non-aqueous solvent. The electrolyte salts preferably include a halogen atom. Examples of the cations constituting the electrolyte salts include lithium ions or sodium ions. Examples of the anions constituting the electrolyte salts include BF₄⁻, PF₆⁻, AsF₆⁻, CF₃SO₃⁻, (CF₃SO₂)₂N⁻, (C₂F₅SO₂)₂N⁻, (C₂F₅SO₂)₂N⁻, (FSO₂)₂N⁻, or (CF₃SO₂)₃C⁻.

The lithium salts are not particularly limited and may be appropriately selected depending on the purpose, and examples of the lithium salts include lithium hexafluorophosphate (LiPF₆), lithium borofluoride (LiBF₄), lithium hexafluoride (LiAsF₆), lithium trifluorometasulfonate (LiCF₃SO₃), lithium bis (trifluoromethylsulfonyl) imide (LiN(CF₃SO₂)₂), lithium (bipentafluoroethylsulfonyl) or imide (LiN(C₂F₅SO₂)₂). Among these, LiPF₆ is preferred from the viewpoint of ionic conductivity, and LiBF₄ is preferred from the viewpoint of stability.

Examples of the sodium salts include sodium hexafluorophosphate (NaPF₆), sodium borofluoride (NaBF₄), sodium hexafluoride (NaAsF₆), sodium trifluorometasulfonate (NaCF₃SO₃), sodium bis(trifluoromethylsulfonyl)imide (NaN(CF₃SO₂)₂), or sodium (bipentafluoroethylsulfonyl)imide (NaN(C₂F₅SO₂)₂), although there is no particular limitation and selection can be made depending on the purpose. The electrolyte salts may be used alone or two or more types may be used in combination.

(Inorganic Particles)

In addition, the gel electrolyte may contain inorganic particles. Inorganic particles include silica (SiO₂), alumina (Al₂O₃), LISICON-type oxides including γ-Li₃PO₄, Li₃BO₄, 0.75Li₄GeO₄-0.25Li₂ZnGeO₄ solid solution, Li₄SiO₄—Zn₂SiO₄ solid solution, Li₄GeO₄—Li₃VO₄ solid solution, NASICON-type oxides including Li_{1.3}A_{10.3}Ti_{1.7}(PO₄)₃ or Li_{1.6}Al_{0.6}Ge_{0.8}Ti_{0.6}(PO₄)₃, perovskite-type structure (Li, La) TiO₃, garnet-type oxide La₅Li₃Nb₂O₁₂, Li₅La₃TaO₁₂. or Li₇La₃Zr₂O₁₂ or the like. At least one of these inorganic particles and the ionic liquid are mixed so that the weight ratio of the ionic liquid to inorganic particles is between 50% and 200% or less.

(Manufacturing Method of Electrode Liquid Composition)

To manufacture an electrode liquid composition, an active material is dispersed in a dispersion medium, an ionic liquid, glyme, and a non-aqueous electrolyte. The mean particle size of the active material is preferably 10 μm or less, and more preferably 5 μm or less. When the mean particle size of the active material is 10 μm or less, discharge stability and settling resistance of the electrode liquid composition are improved. The active material d10 is preferably 0.1 μm or more, and more preferably 0.15 μm or more. A d10 of active material greater than 0.1 μm improves the storage stability of the electrode liquid composition. The electrode liquid composition according to the first embodiment may further include conductivity aids, dispersants, binders, solid electrolytes, gel electrolytes, monomers to become gel electrolytes through a polymerization process, and the like, as desired. Preferably, the viscosity of the electrode liquid composition at 25° C. is in the range of 3 mPa·s or more and 100 mPa·s or less. More preferably, the viscosity of the electrode liquid composition at 25° C. is 9 mPa·s or more and 50 mPa·s or less.

Here, the mean particle size refers to the volume mean particle size based on the effective diameter, and the mean particle size is measured by, for example, a laser diffraction/scattering method or a dynamic light scattering method. The viscosity of the electrode liquid composition at 25° C. is measured at 100 rpm with a No. CPA-40Z rotor attached to a B-type viscometer (cone plate viscometer).

(Formation of Separator)

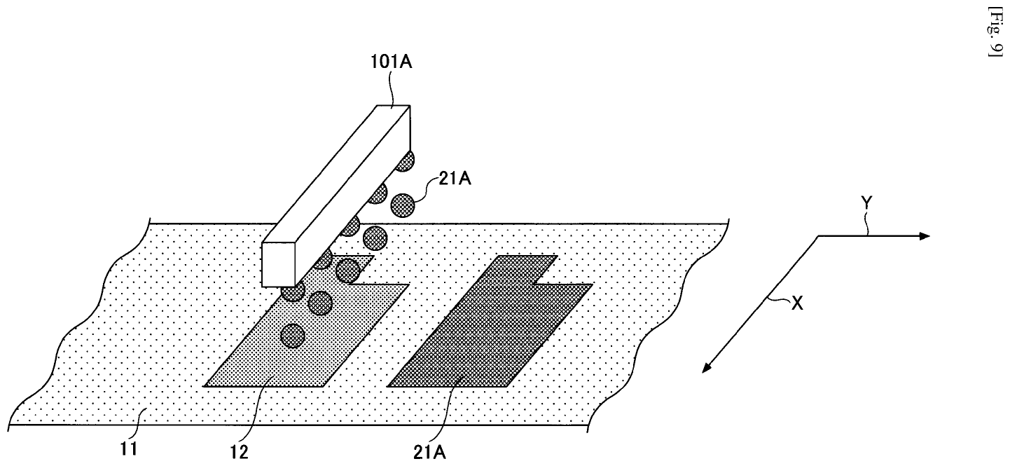

As illustrated in FIG. 4 or 5, after positional information of the electrode mixture layer 12 is acquired by image recognition, an insulating layer liquid composition 21B containing a compound having a polymerizable site for formation of an electron insulating layer 21 is inkjet printed on the electrode mixture layer 12, as illustrated in FIG. 10. The insulating layer liquid composition 21B is then applied to cover the entire surface (top and sides) of the electrode mixture layer 12. The insulating layer liquid composition 21B forms a crosslinkable structure by application of light or heat, which becomes the electron insulating layer 21 upon drying. It should be noted that the insulating layer liquid composition 21B is an example of a liquid composition containing an electron insulating layer forming material without containing an active material.

(Electron Insulating Layer Forming Material)

The polymerizable compound is a precursor of a resin for forming the electron insulating layer 21, and is not particularly specified insofar as the resin is capable of forming an electron insulating layer, which is crosslinkable by the application of light or heat. Examples of the polymerizable compound include an acrylate resin, a methacrylate resin, a urethane acrylate resin, a vinyl ester resin, an unsaturated polyester, an epoxy resin, an oxetane resin, and a resin that utilizes a vinyl ether or a thiol-ene reaction. Of these, an acrylate resin, a methacrylate resin, a urethane acrylate resin, or a vinyl ester resin, which can easily form an electron insulating layer by using radical polymerization due to their high reactivity, are particularly preferred in terms of productivity.

The above resin can be acquired by preparing a mixture of a polymerizable monomer and a compound that generates radicals or acids by light or heat as a function that can be cured by light or heat. In order to form the electron insulating layer 21 by polymerization induced phase separation, an ink in which a porogen is pre-mixed with the above-described mixture may be prepared.

The polymerizable compound has at least one radically polymerizable functional group. Examples include monofunctional, bifunctional or trifunctional or higher radically polymerizable compounds, functional monomers, radically polymerizable oligomers, etc. Of these, bifunctional or higher radically polymerizable compounds are particularly preferable.

Examples of monofunctional radically polymerizable compounds include 2-(2-ethoxyethoxy)ethylacrylate, methoxypolyethylene glycol monoacrylate, methoxypolyethylene glycol monomethacrylate, phenoxypolyethylene glycol acrylate, 2-acryloyloxyethylsuccinate, 2-ethylhexyl acrylate, 2-hydroxyethyl acrylate, 2-hydroxypropyl acrylate, tetrahydrofuryl acrylate, 2-ethylhexyl carbitol acrylate, 3-methoxybutyl acrylate, benzyl acrylate, cyclohexyl acrylate, isoamyl acrylate, isobutyl acrylate, methoxytriethylene glycol acrylate, phenoxytetraethylene glycol acrylate, cetyl acrylate, isostearyl acrylate, stearyl acrylate or styrene monomers. These may be used alone or in combination with two or more types.

Examples of bifunctional radically polymerizable compounds include 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacrylate, polyethylene glycol diacrylate, neopentyl glycol diacrylate, EO modified bisphenol A diacrylate, EO modified bisphenol F diacrylate, neopentyl glycol diacrylate, or tricyclodecandinol diacrylate. These may be used alone or in combination with two or more types.

Examples of trifunctional or higher radically polymerizable compounds include trimethylolpropanetriacrylate (TMPTA), trimethylolpropanetrimethacrylate, trimethylolpropanetriacrylate, EO-modified trimethylolpropanetriacrylate, PO-modified trimethylolpropanetriacrylate, caprolactone-modified trimethylolpropanetriacrylate, HPA-modified trimethylolpropanetrimethacrylate,
pentaerythritol triacrylate, pentaerythritol tetraacrylate (PETTA), glycerol triacrylate, ECH-modified glycerol triacrylate, EO-modified glycerol triacrylate,
PO-modified glycerol triacrylate, tris(acryloxyethyl) isocyanurate, pentaerythritol hexaacrylate (DPHA), caprolactone-modified dipentaerythritol hexaacrylate, dipentaerythritol hydroxypentaacrylate, alkyl-modified dipentaerythritol pentaacrylate, alkyl-modified dipentaerythritol tetraacrylate, alkyl-modified dipentaerythritol triacrylate, dimethylol-propanetetraacrylate (DTMPTA), pentaerythritol ethoxytetraacrylate, EO-modified triacrylate, or 2,2,5,5-tetrahydroxymethylcyclopentanone tetraacrylate. These may be used alone or in combination with two or more types.

As the photopolymerization initiator, a photo-radical generant may be used. For example, photoradical initiators such as mihiraketone and benzophenone, known in the trade names Ilgacure and Darocua may be used. More specific examples of preferably used compounds include benzophenone, acetophenone derivatives such as α-hydroxy- or α-aminosetophenone, 4-aroyl-1,3-dioxolane, benzyl ketal, 2,2-diethoxyacetophenone, p-dimethylaminoacetophene, pdimethylaminopropiophenone, benzophenone, 2-chlorobenzophenone, pp′-dichlorobenzophene, pp′-bis-diethylaminobenzophenone, Michler's ketone, benzyl, benzyonin, benzyl dimethyl ketal, tetramethylthiuram monosulfide, thioxantone, 2-chlorothioxanthonton, 2-methylthioxantone, azobisisobutyronitrile, benzoinperoxide, di-tert-butyl peroxide, 1-hydroxycyclohexylphenyl ketone, 2-hydroxy-2-methyl-1-phenyl-1-one, 1-(4-isopropylphenyl)-2-hydroxy-2-methylpropan-1-one, methylbenzoylformate, benzoin isopropyl ether, benzoin methyl ether, benzoin ethyl ether, benzether, benzoin isobutyl ether, benzoin n-butyl ether, benzoin n-propyl ether, and other benzoin alkyl ether or esters; 1-hydroxy-cyclohexyl-phenyl-ketone, 2-benzyl-2-dimethylamino-1-(4-morpholinophenyl)-butanone-1, 1-hydroxy-cyclohexyl-phenyl-ketone, 2,2-dimethoxy-1,2-diphenylethane-1-one, bis(η5-2,4-cyclopentadiene-1-yl)-bis(2,6-difluoro-3-(1H-pyrrole-1-yl)-phenyl)titanium, bis(2,4,6-trimethylbenzoyl)-phenyl phosphine oxide, 2-methyl-1[4-(methylthio)phenyl]-2-morpholinopropan-1-one, 2-hydroxy-2-methyl-1-phenyl-propane-1-one (Darocur 1173), bis(2,6-dimethoxybenzoyl)-2,4,4-trimethyl-pentylphosphine oxide, 1-[4-(2-hydroxyethoxy)-phenyl]-2-hydroxy-2-methyl-1-propan-1-onmonoacylphosphine oxide, bis acylphosphine or titanocene, fluorecene, anthraquinone, thioxantone or xanthone, rofindimer, trihalomethyl compound or dihalomethyl compound, active ester compound, organoboron compound, and the like.

In addition, photocrosslinkable radical generators such as bisazide compounds may be included at the same time. In addition, when polymerizing with heat alone, a conventional thermal polymerization initiator, such as A (AIBN), which is a conventional photoradical generator, may be used.

Or, a similar function can be achieved by preparing the mixture with at least one monomer that polymerizes in the presence of acid and a photoacid generator that generates acid by the application of light. When such a liquid ink is applied with light, a photoacid generator generates an acid that functions as a catalyst in the cross-linking reaction of polymerizable compounds.

The generated acid also diffuses in the ink layer. Moreover, acid diffusion and acid-catalyzed crosslinking reactions can be accelerated by heating, and unlike radical polymerization, these crosslinking reactions are not inhibited by the presence of oxygen. The resulting resin layer has excellent adhesion compared to the case of a radical polymerization system.

Examples of polymerizable compounds crosslinked in the presence of an acid include compounds having a cyclic ether group such as an epoxy group, an oxetane group, an oxolane group, and the like, acrylic or vinyl compounds having a substituent group as described above, carbonate-based compounds, low molecular weight melamine compounds, vinyl ethers, vinyl carbazoles, styrene derivatives, α-methylstyrene derivatives, vinyl alcohol, vinyl alcohol esters including ester compounds such as acrylic and methacrylic, and monomers having a cationic polymerizable vinyl bond.

Examples of a photoacid generator that generates acids by the application of light include an onium salt, a diazonium salt, a quinone diazide compound, an organic halide, an aromatic sulfonate compound, a bisulfone compound, a sulfonyl compound, a sulfonate compound, a sulfonium compound, a sulfamide compound, an iodonium compound, or a sulfonyldiazomethane compound, and mixtures of these compounds.

Among these, it is preferable to use an onium salt as the photoacid generator. Examples of usable onium salts include fluoroborate anion, hexafluoroantimonate anion, hexafluorohyanate anion, trifluoromethanesulfonate anion, paratoluenesulfonate anion, and diazonium, phosphonium, and sulfonium salts having paranitrotoluenesulfonate anion as a counterion. Photoacid generators can also be used with halogenated triazine compounds.

The photoacid generator may optionally further include a sensitizing dye. Examples of sensitizing dyes include acridine compounds, benzoflavins, perylenes, anthracenes, and laser dyes.

The porogen is mixed to form a hole in the electron insulating layer 21 after curing. As a porogen, any liquid material capable of dissolving the polymerizable monomer and a compound that generates radicals or acids by light or heat, and causing phase separation in the process of polymerization of the polymerizable monomer and a compound that generates radicals or acids by light or heat may be used.

Examples of the polyogen include ethylene glycols such as diethylene glycol monomethyl ether, ethylene glycol monobutyl ether, dipropylene glycol monomethyl ether, esters such as γ-butyrolactone and propylene carbonate, or amides such as NN dimethyl acetamide.

Also, relatively large molecular weight liquid materials such as methyl tetradecanoate, methyl decanoate, methyl myristate, and tetradecane tend to function as porogenes. Especially, many ethylene glycols have high boiling points. Phase separation mechanisms depend largely on the concentration of the porogen. Thus, if the above liquid materials are used, a stable electron insulating layer 21 can be formed. Also, porogen may be used alone or in combination with two or more species.

As in the first embodiment, the substrate 11 is cut at a desired position in the region where the electron insulating layer 21 is not formed (the region where the insulating layer liquid composition 21B is not applied). As illustrated in FIGS. 7 and 8, the electrode 20 having an electrode end structure capable of preventing the electrode mixture layer 12 from being exposed, and capable of preventing short circuiting inside the battery due to slippage of active material or the like can be acquired.

(Printing of Current Collector)

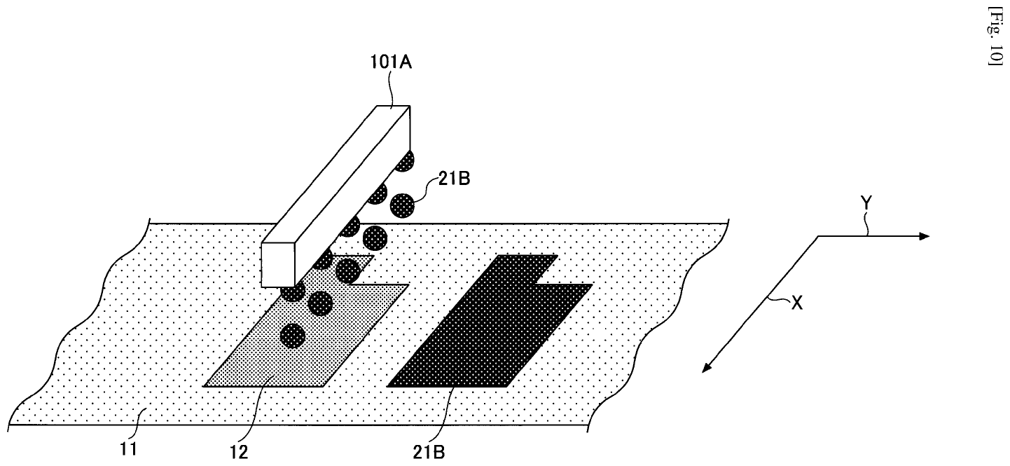

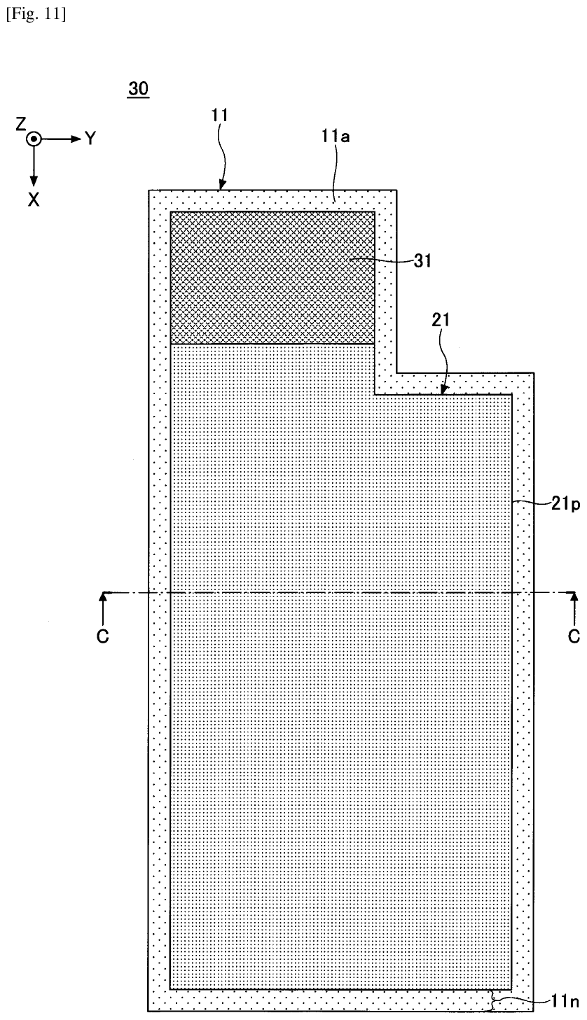

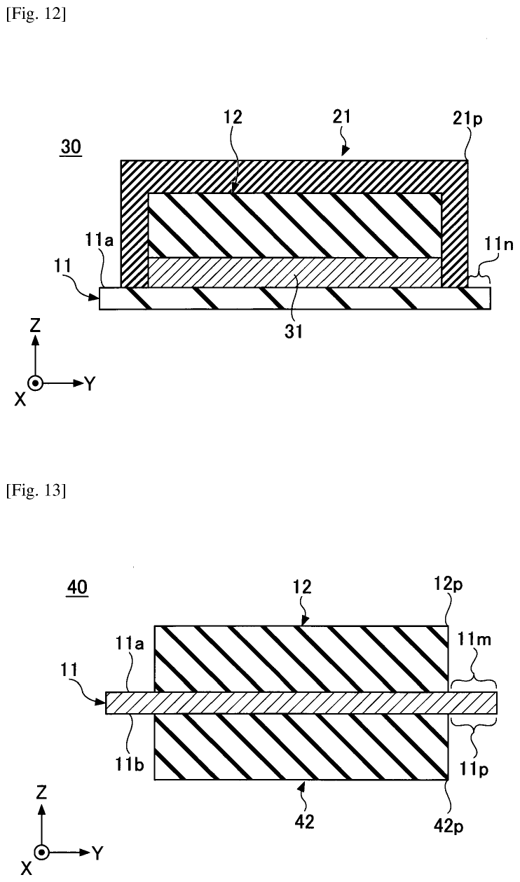

FIG. 11 is a plan view illustrating an example of an electrode according to a modification of the second embodiment. FIG. 12 is a cross-sectional view illustrating an example of the electrode according to the modification of the second embodiment, representing a cross-section along a line C-C of FIG. 11. When an insulating substrate is used as the substrate 11, it is necessary to form an electrically conductive layer 31 for current collection, as illustrated in the electrodes 30 illustrated in FIGS. 11 and 12. A portion of the electrically conductive layer 31 is exposed at the end of the electron insulating layer 21.

To form the electrically conductive layer 31, a conductive liquid composition containing, for example, at least one type of metal nanoparticles or fiber of silver, copper, gold, nickel, and aluminum, or a highly conductive carbon material such as carbon nanotubes or graphene, or a conductive ceramic such as titanium nitride.

Inkjet printing discharges the liquid composition described above onto the insulating substrate 11 to form the electrically conductive layer 31. According to inkjet printing, the electrically conductive layer 31 can be formed in a desired shape on the substrate 11.

Preferably, the mean particle size of the dispersion in the liquid composition for forming the electrically conductive layer is 0.01 μm or more and 3 μm or less, and the viscosity of the liquid composition for forming the electrically conductive layer is preferably in the range of 3 mPa·s or more and 18 mPa·s or less at 25° C.

When the mean particle size of the dispersion in the liquid composition for forming the electrically conductive layer is 0.01 μm or more, the discharge stability of the liquid composition is stabilized, and when the particle size is 3 μm or less, the storage stability of the liquid composition is improved. In addition, when the viscosity of the liquid composition for forming the electrically conductive layer is in the range of 3 mPa·s or more and 18 mPa·s or less at 25° C., it is easy to discharge the liquid as a droplet, so that the discharge amount can be easily controlled.

After the printing step, the liquid composition can be baked by a baking method commonly used in the art. In the case of metal nanoparticles, it is more preferably dried and fired in a vacuum of 10⁻⁴ Pa or less, under a nitrogen atmosphere, or under an argon atmosphere to prevent oxidation. Optical calcination with xenon flash lamps can also be used to enhance sintering.

### Third Embodiment

A third embodiment represents an example of an electrode having an electrode mixture layer on both sides of the substrate. FIG. 13 is a cross-sectional view illustrating an example of an electrode according to the third embodiment. The plan view of the electrode according to the third embodiment is the same as that of FIG. 1.

As illustrated in FIG. 13, an electrode 40 differs from the electrode 10 (see FIGS. 1 and 2) in that an electrode mixture layer 42 is formed on a second surface 11b of the substrate 11. The electrode mixture layer 42 is formed, for example, in a position that overlaps the electrode mixture layer 12 in a plan view. The thickness of the electrode mixture layer 42 is the same as, for example, the thickness of the electrode mixture layer 12.

In the second surface 11b of the substrate 11, an uncoated portion 11p is disposed in an annular shape on the outside of an outer peripheral portion 42p of the electrode mixture layer 42. The uncoated portion 11p is a portion of the substrate 11 in which the second surface 11b of the substrate 11 is exposed without being coated with the electrode mixture layer 42. The uncoated portion 11p is formed, for example, in a position overlapping the uncoated portion 11m in a plan view.

(Double-Sided Application)

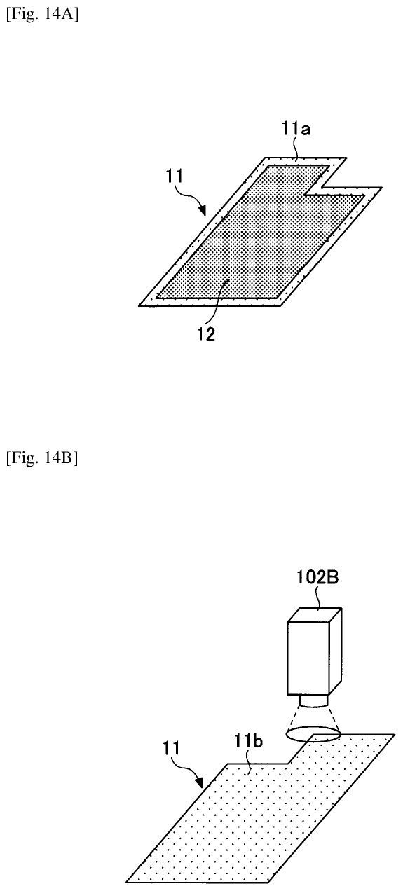

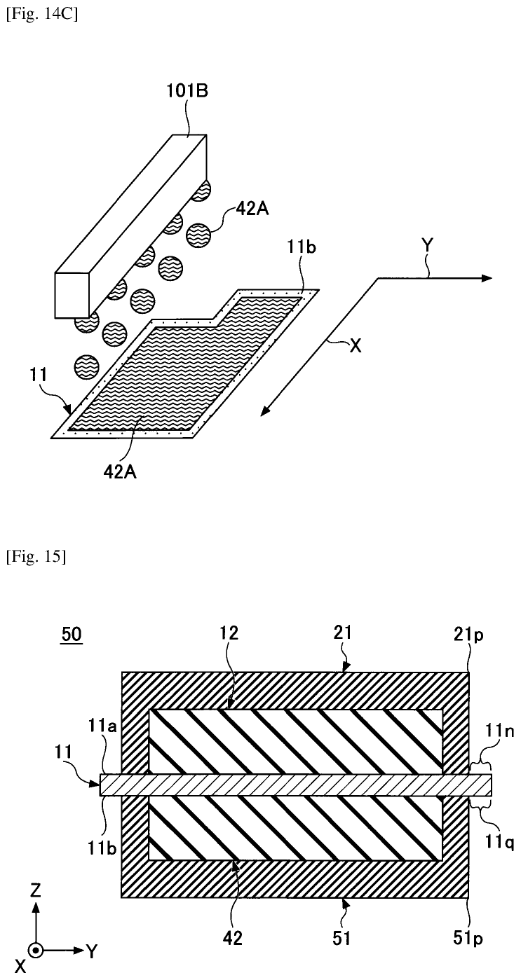

FIGS. 14A to 14C are diagrams illustrating an example of an electrode manufacturing method according to the third embodiment. As illustrated in FIG. 14A, after the substrate 11 on which the electrode mixture layer 12 is formed is cut, the substrate 11 is inverted upside down as illustrated in FIG. 14B, and image recognition is performed by the image sensor 102B with respect to an end of the cut substrate 11 so as to acquire positional information of the electrode mixture layer 12. Then, as illustrated in FIG. 14C, an electrode liquid composition containing an electrode mixture material 42A is applied to the second surface 11b of the substrate 11 so as to overlap with the position of the electrode mixture layer 12 in a plan view. The electrode liquid composition containing the electrode mixture material 42A can be applied using an inkjet head 101B in a manner similar to the case of the electrode liquid composition containing the electrode mixture material 12A. The electrode liquid composition containing the electrode mixture material 42A may be similar to or different from the electrode liquid composition containing the electrode mixture material 12A.

It should be noted that a method of identifying the position of the substrate 11 by performing image recognition with respect to the end shape of the substrate 11 using the image sensor 102B may also be used in the case of single-sided application. For example, in manufacturing the electrode 20 illustrated in FIG. 7 or the like, only the substrate 11 may be cut from a structure in which the electrode mixture layer 12 is formed on the substrate 11, image recognition may then be performed with respect to an end shape of the substrate 11 using the image sensor 102B, and the electrolyte liquid composition 21A or the insulating layer liquid composition 21B covering the electrode mixture layer 12 may be applied.

(Application of Bipolar Electrode)

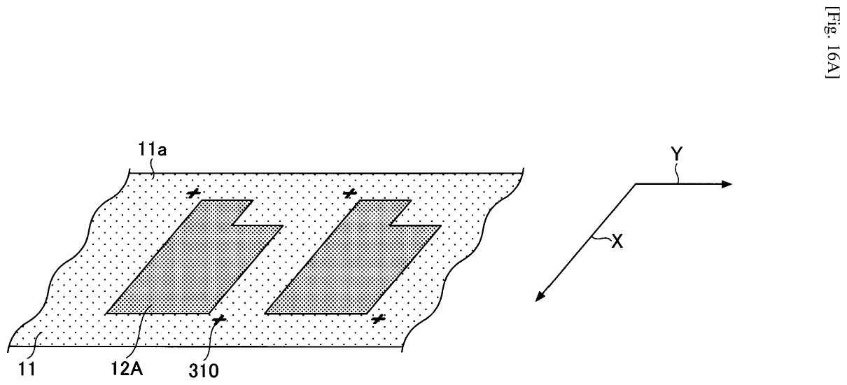

Specifically, a bipolar electrode can be formed by applying an electrode liquid composition containing the electrode mixture material 42A having a different polarity from the electrode liquid composition containing the electrode mixture material 12A. Electron insulating layers 21 and 51 may also be formed on the first surface 11a and the second surface 11b of the substrate 11 to coat the electrode mixture layers 12 and 42, as an electrode 50 illustrated in FIG. 15.

In the second surface 11b of the substrate 11, an uncoated portion 11q is disposed in an annular shape on the outside of an outer peripheral portion 51p of an electron insulating layer 51 in a plan view. The uncoated portion 11q is a portion of the substrate 11 in which the second surface 11b of substrate 11 is exposed without being coated with the electrode mixture layer 42 or the electron insulating layer 51. The uncoated portion 11q is formed, for example, in a position overlapping the uncoated portion 11n in a plan view.

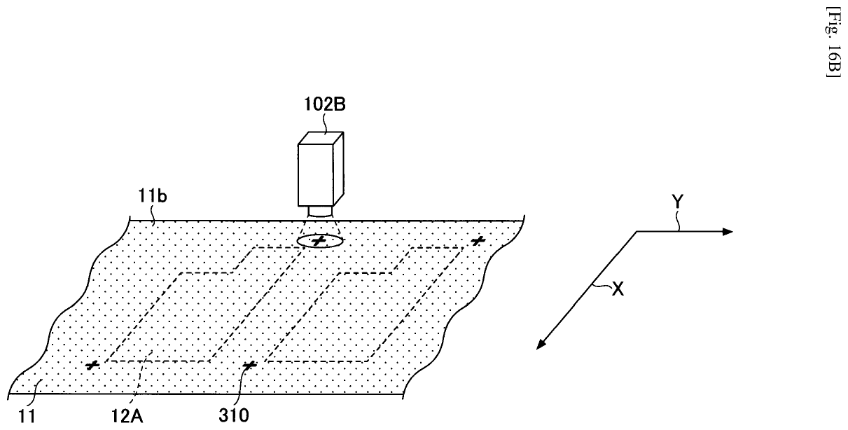

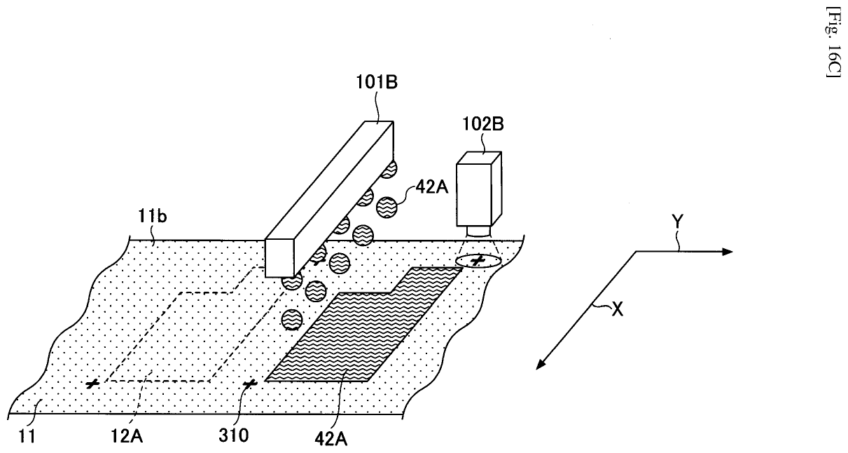

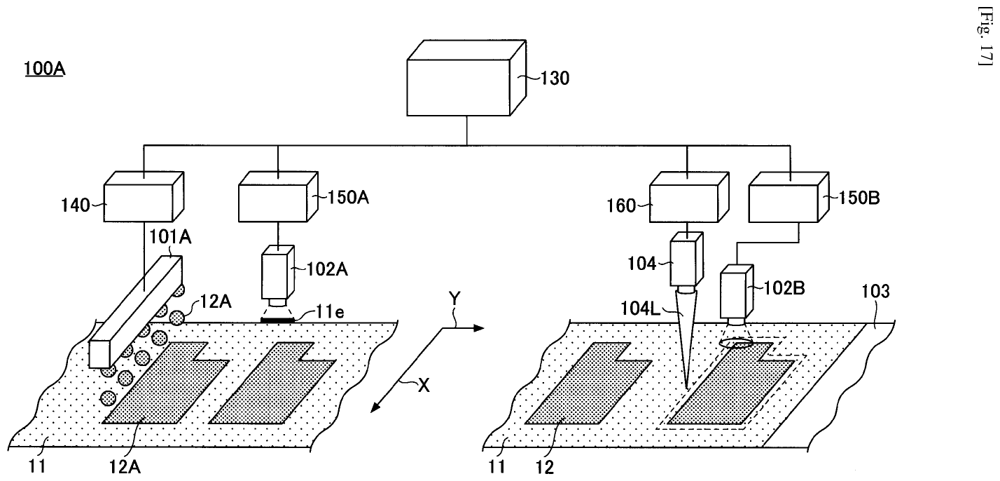

The coating of the second surface 11b may be performed between a step of applying the electrode liquid composition containing the electrode mixture material 12A onto the substrate 11 and a step of cutting only substrate 11, as illustrated in FIGS. 16A to 16C. In FIGS. 16A to 16C, an alignment mark 310 is a through-hole formed in the substrate 11 by laser processing. In this case, positional information of the electrode liquid composition containing the electrode mixture material 12A can be acquired from the second surface 11b of the substrate 11 by image recognition performed with respect to the alignment mark 310.

First, as illustrated in FIG. 16A, an electrode liquid composition containing the electrode mixture material 12A is applied to the first surface 11a of the substrate 11. Subsequently, as illustrated in FIG. 16B, the substrate 11 is inverted. The image sensor 102B then performs image recognition with respect to the alignment mark 310 from the second surface 11b of the substrate 11 to read positional information of the electrode liquid composition containing the electrode mixture material 12A. Then, as illustrated in FIG. 16C, the inkjet head 101B applies the electrode liquid composition containing the electrode mixture material 42A to the second surface 11b of the substrate 11 so as to overlap the position of the electrode liquid composition containing the electrode mixture material 12A in a plan view.

Note that when the alignment mark is visually perceived only from the first surface 11a of the substrate 11, image recognition may be performed with respect to the alignment mark from the first surface 11a of the substrate 11, and the electrode liquid composition containing the electrode mixture material 42A may be applied to the second surface 11b by matching timing based on the conveying speed of the substrate 11.

(Electrode Manufacturing Apparatus)

FIG. 17 is a schematic diagram illustrating an example of an electrode manufacturing apparatus. As illustrated in FIG. 17, an electrode manufacturing apparatus 100A includes an inkjet head 101A, image sensors 102A and 102B, a conveying belt 103, a laser head 104, a control device 130, an inkjet printing control board 140, image sensor control boards 150A and 150B, and a laser processing control board 160. The control device 130 may provide various commands to the inkjet printing control board 140, image sensor control boards 150A and 150B, and laser processing control board 160.

The inkjet head 101A is an example of a tool configured to apply an electrode liquid composition containing an electrode mixture material in a desired shape at a desired position on a substrate. The image sensors 102A and 102B are each an example of a tool configured to acquire positional information at which an electrode liquid composition containing an electrode mixture material is applied. The laser head 104 is an example of a tool configured to cut only a substrate at a desired position in a region other than a region in which the electrode liquid composition containing an electrode mixture material is applied, and to cut an electrode in a desired shape. The electrode manufacturing apparatus 100A can control, using digital data, a desired position as to where an electrode liquid composition containing an electrode mixture material is applied, a desired shape of the electrode liquid composition containing the electrode mixture material, and a desired position as to where the substrate is cut.

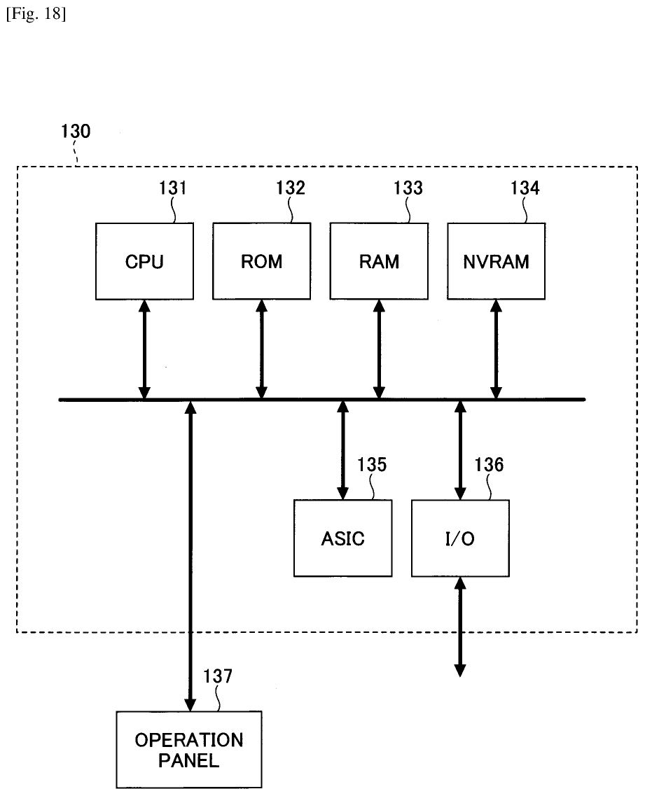

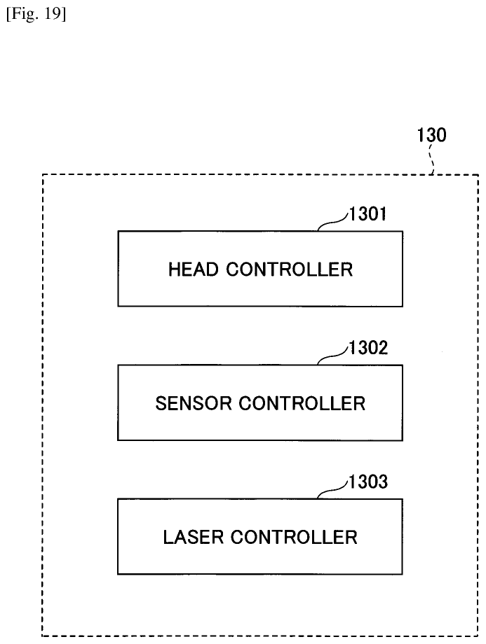

FIG. 18 is a block diagram illustrating examples of main hardware components of a controller. As illustrated in FIG. 18, in the electrode manufacturing apparatus 100A, a control device 130 includes a CPU 131, a ROM 132, a RAM 133, an NVRAM 134, an ASIC 135, an I/O 136, and an operation panel 137.

The CPU 131 is responsible for controlling the entire electrode manufacturing apparatus 100A. The ROM 132 stores programs executed by the CPU 131 and other fixed data. The RAM 133 temporarily stores data, etc. relating to the electrode manufacturing. The NVRAM 134 is a non-volatile memory for holding data while the power to the device is off. The ASIC 135 performs various signal processing for the image data, image processing for sorting and the like, and other input and output signals for controlling the entire device. The I/O 136 is an interface for inputting and outputting signals to and from the inkjet printing control board 140, the image sensor control boards 150A and 150B, and laser processing control board 160. The operation panel 137 performs input and display of necessary information for the control device 130.

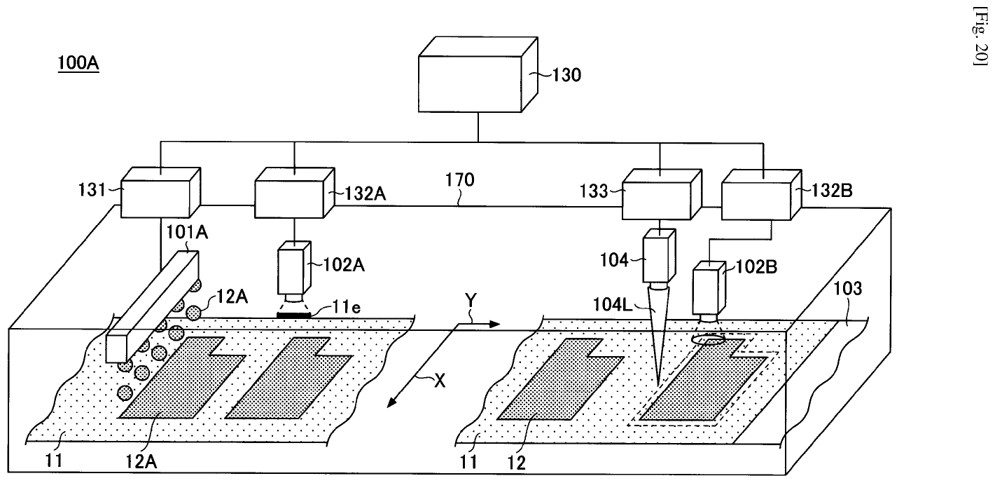

FIG. 19 is a block diagram illustrating examples of main functions of the controller. As illustrated in FIG. 19, the control device 130 includes a head controller 1301, a sensor controller 1302, and a laser controller 1303 as a function block.

The head controller 1301 issues a drive instruction to the inkjet printing control board 140 at a designated timing and the number of drops under discharge conditions such as the given waveform data and the discharge frequency. The sensor controller 1302 issues instructions to the image sensor control boards 150A and 150B and acquires from the image sensors 102A and 102B necessary information including positional information on the electrode liquid composition containing electrode mixture material. The laser controller 1303 provides a command to the laser processing control board 160 to control the amount of outgoing light required to cut the substrate 11 and to scan the laser light based on the positional information of the electrode liquid composition containing the electrode mixture material acquired by the sensor controller 1302.

By using the electrode manufacturing apparatus 100A illustrated in FIGS. 17 to 19, the design can be changed by transferring digital data, an electrode having a desired shape can be formed by inkjet printing, and the electrode can be cut out in a desired shape by laser processing. In this manner, design data for an electrode shape is transferred from the control device 130 to each of the inkjet printing control board 140, the image sensor control boards 150A and 150B, and the laser processing control board 160. This enables switching to electrode manufacturing of different designs without redesigning or replacement of masks and plates.

(Environment of Coating Process)

Further, liquid compositions that become electrodes or electrolytes also include materials that react with moisture in the atmosphere to cause performance degradation. Especially, it is known that the solid electrolyte of sulfide is accompanied by the generation of toxic hydrogen sulfide gas by reaction with water, and strict water control is required. The process of exposing the material reactive with such moistures is preferably conducted under an inert gas environment, such as dry air, nitrogen or argon, having a low dew point. The electrode liquid composition containing the electrode mixture material is preferably applied at least in an environment filled with dry air or inert gas at a dew point of −40° C. or less. Also, the environment filled with dry air or inert gas is more preferably positive pressure with respect to the external environment.

In the electrode manufacturing method according to the first embodiment and the like, a series of electrode manufacturing steps from applying a liquid composition to cutting an electrode can be controlled by only the exchange of digital data, and can be operated remotely. For example, the electrode liquid composition containing the electrode mixture material may be applied under an environment filled with dry air or inert gas at a dew point of −40° C. or less, and the position and shape of the electrode liquid composition containing the electrode mixture material may be changed while maintaining this environment.

For example, as illustrated in FIG. 20, only a limited space 170 in which the steps of applying the liquid composition and cutting the substrate are performed is under a locally moisture controlled environment. This enables electrode manufacturing while ensuring performance and safety. Accordingly, the cost of stopping and replacing the production line with the design change and the running cost of controlling the atmosphere in the limited space can be reduced, enabling the electrode to be manufactured at a low cost.

Although the preferred embodiments have been described in detail above, various modifications and substitutions can be applied to the embodiments described above without departing from the scope of the claims.

### REFERENCE SIGNS LIST

10, 20, 30, 40, 50 electrode
11 substrate
11a first surface of substrate 11
11b second surface of substrate 11
11c position
11e end of substrate 11
11m, 11n, 11p, 11q uncoated portion
12, 42 electrode mixture layer
12A, 42A electrode mixture material
12p outer peripheral portion of electrode mixture layer 12
21 electron insulating layer
21A electrolyte liquid composition
21B insulating layer liquid composition
21p outer peripheral portion of electron insulating layer 21
31 electrically conductive layer
42p outer peripheral portion of electrode mixture layer 42
51p outer peripheral portion of electron insulating layer 51
100, 100A electrode manufacturing apparatus
101A, 101B inkjet head
102A, 102B image sensor
103 conveying belt
104 laser head
104L laser light
130 control device
131 CPU
132 ROM
133 RAM
134 NVRAM
135 ASIC
136 I/O
137 operation panel
140 inkjet printing control board
150A, 150B image sensor control board
160 laser processing control board
300, 310 alignment mark
1301 head controller
1302 sensor controller
1303 laser controller

The present application is based on Japanese Priority Application No. 2021-032921 filed on Mar. 2, 2021, and Japanese Priority Application No. 2021-215007 filed on Dec. 28, 2021, the entire contents of which are hereby incorporated herein by reference.

1. An electrode manufacturing method comprising:
a first step of applying an electrode liquid composition in a desired shape at a desired position on a substrate, the electrode liquid composition containing an electrode mixture material;
a second step of acquiring positional information as to where the electrode liquid composition is applied; and
a third step of cutting only the substrate at a desired position in a region other than an electrode mixture material region where the electrode liquid composition is applied to obtain an electrode cut out in a desired shape.

2. The electrode manufacturing method according to claim 1, wherein
the desired position as to where the electrode liquid composition is applied, the desired shape in which the electrode liquid composition is applied, and the desired position as to where the substrate is cut in the first to third steps are controllable by a control device.

3. The electrode manufacturing method according to claim 2, wherein
the desired position as to where the electrode liquid composition is applied, the desired shape in which the electrode liquid composition is applied, and the desired shape at which the substrate is cut are controllable based on digital data by the control device.

4. The electrode manufacturing method according to claim 1, wherein
in the first step, the electrode liquid composition is discharged from a nozzle.

5. The electrode manufacturing method according to claim 1, wherein
in the third step, only the substrate is cut by laser light.

6. The electrode manufacturing method according to claim 1, wherein
in the second step, the positional information is acquired by image recognition performed with respect to an end shape of the electrode mixture material region.

7. The electrode manufacturing method according to claim 1, wherein
in the second step, the positional information is acquired by image recognition performed with respect to a mark, the mark being formed by printing the electrode liquid composition in a region other than the electrode mixture material region.

8. The electrode manufacturing method according to claim 1, wherein
in the second step, the positional information is acquired by image recognition performed with respect to a hole formed in the substrate.

9. The electrode manufacturing method according to claim 1, wherein
in the second step, the positional information is acquired by image recognition performed with respect to an end of the substrate, the substrate being cut in a desired shape.

10. The electrode manufacturing method according to claim 1, wherein the substrate is a single sheet of metallic foil or an insulating substrate.

11. The electrode manufacturing method according to claim 1, wherein
the substrate is a strip of metallic foil or an insulating substrate.

12. The electrode manufacturing method according to claim 1, wherein
in the first step, as the electrode liquid composition containing an electrode mixture material, a liquid composition containing an active material is applied to form an electrode mixture layer, and
after the first step, a step of applying a liquid composition containing an electron insulating layer forming material without the active material onto the electrode mixture layer to form an electron insulating layer on the electrode mixture layer, the electron insulating layer covering the entire electrode mixture layer.

13. The electrode manufacturing method according to claim 1, further comprising:
between the first step and the second step, a step of inverting the substrate and applying the electrode liquid composition at a desired position on a second surface of the substrate, the second surface being a surface on which the electrode liquid composition has not been applied.

14. The electrode manufacturing method according to claim 1, wherein
at least the first step is conducted under an environment filled with dry air or an inert gas at a dew point of −40° C. or less, and a position at which and a shape in which the electrode liquid composition is applied are changeable while maintaining the environment.

15. An electrode manufacturing apparatus comprising:
an applier to apply an electrode liquid composition in a desired shape at a desired position on a substrate, the electrode liquid composition containing an electrode mixture material;
acquiring circuitry configured to acquire positional information as to where the electrode liquid composition is applied;
a cutter to cut only the substrate at a desired position in a region other than an electrode mixture material region where the electrode liquid composition is applied to obtain an electrode cut out in a desired shape; and
control circuitry configured to control the desired position as to where the electrode liquid composition is applied, the desired shape in which the electrode liquid composition is applied, and the desired position as to where the substrate is to be cut by the cutter.
